(19) United States
(12) Patent Application Publication
(10) Pub. No.: US 2004/0218069 A1
(43) Pub. Date: Nov. 4, 2004

(54) Single image digital photography with structured light for document reconstruction

(76) Inventor: D. Amnon Silverstein, Mtn. View, CA (US)

Correspondence Address: HEWLETT-PACKARD COMPANY, Intellectual Property Administration, P.O. Box 272400, Fort Collins, CO, 80527-2400, US

(21) Appl. No.: 09/823,366

(22) Filed: Mar. 30, 2001

(51) Int. Cl. H04N 5/225

(52) U.S. Cl. 348/239

(57) ABSTRACT

A system and method of obtaining a reconstructed digital image of an image that is projected, displayed, or printed on a surface by capturing a single digital image of the surface is described. According to the system and method, at least three illumination marks are projected onto the surface. The illumination marks have a particular detectable characteristic. An image captures a single image of the surface including the illumination marks to obtain captured image data. The location and the pixel values corresponding to the illumination marks are detected dependent on the particular characteristic of the illumination mark pixels in the captured image data. The locations of the illumination marks are then used to correct for distortion of the image and surface in the captured image data to generate an undistorted digital image of the image on the surface. The illumination mark pixel values are replaced within undistorted digital image with estimated pixel values that are determined using neighboring non-illumination mark pixel values.

### FIELD OF THE INVENTION

The present invention relates to image capture using a photographic device and in particular to document image capture using a camera.

### BACKGROUND OF THE INVENTION

Reproducing a document requires that the two-dimensional surface image is recovered from a three dimensional object such as a sheet of paper. Copy machines are generally thought of as the standard means for document reproduction. A sheet of glass is used to precisely position the document, and a weighted door is used to press the document as flat as possible. This constrains the document to a precise two-dimensional structure, and reproduction is straight forward. An alternative technique to using a copier is to use an image capture device, such as a digital camera, to obtain a digital image of a document. One of the main advantages of using a camera to reproduce a document is that the camera is portable such that it can be easily positioned over the document to be duplicated. For instance, if it is desired to obtain a copy of a page in a book, the camera can be brought to the location of the book and a digital image of the document page can be captured by the camera. This technique is contrasted to obtaining a copy of the same page using a standard copier or scanner, in which it is necessary to place the book face down on the imaging plate of the copier/scanner, close the copier/scanner cover and flatten the spine of the book in an attempt to obtain a non-distorted copy of the page. In the case of a valuable, antique, or frail book, this practice is extremely undesirable. In another example, copies of a chalk or white boards may be desired. These types of images cannot be reproduced by a copier or scanner. Another disadvantage of using a copier or scanner is that the resulting reproduced document is often distorted due to the position of the document surface with respect to the sensor of the copier or scanner.

When a document is reproduced with a camera, it is generally desirable to use a copy stand for placing the document into. The copy stand maintains a fixed position between the camera and the document, and the document is held reasonably flat. The problem with this technique is that it is not very portable. In addition, the document needs to be placed on the copy stand which may not be possible if the document is, for example, a whiteboard. Moreover, the document may be difficult to position/flatten if it is thick or curved such as is the case with the pages of a thick book.

Another technique for reproducing the surface of a three dimensional object (e.g., a sheet of paper) is performed by projecting registration or fiducial marks onto the surface of the object. The surface geometry of the object is then reconstructed with one or a set of images including the projected markings while the surface reflectance is reconstructed with a second image or set of images without the markings.

FIG. 1 shows a flow chart of the steps for reproducing a surface of a document by projecting fiducials. According to the shown method, two images are obtained using a stationary, precisely positioned camera (block 10). Typically, the positioning of the camera is achieved using a tripod. While the camera is in the fixed position, a first image of the original document is captured (block 11). Next, while maintaining the same position, a set of illumination marks, referred to as fiducials, generated by a light source are projected on the document (block 12) and a second image is captured (block 13). The second image provides the digital information corresponding to the document image content (i.e., the printing, pictures, or photos on the document surface) while the first image provides digital information relating to the position of the document with respect to the camera. The position information may be used to model the document's original geometry. The modeled document geometry obtained from this image is then used to process the image content on the surface information obtained from the second captured image to obtain a reconstructed undistorted reproduction of the document (block 14). The main reason that two images are used according to this technique is because by projecting fiducials onto the image, original image data is lost (i.e., covered up) at the locations of the fiducials. As a result, two images are obtained—one to provide all of the original image content and one to provide the geometry information using the fiducials.

FIG. 2 shows an example of the images captured in order to reproduce a document according to the technique shown in FIG. 1. A first image 20 of the document is captured without fiducials. As can be seen, the shape of the document (i.e., document geometry) and its text are distorted due to perspective distortion created by the position of the camera with respect to the document. Specifically, distortion can occur due to camera rotation, pitch, yaw, etc with respect to the document surface. Hence, in general, unless the document surface and the camera sensor are perfectly orthogonal along all axes, the reproduced document will be distorted. FIG. 2 also shows the second captured image 21 with fiducials. As can be seen, since the camera remains stationary, any distortion seen in the first captured image 20 will be identical to the distortion seen in the second captured image 21. At least the first and second captured images (20 and 21) are required according to this prior art method to reconstruct the non-distorted image 22 of a document.

There are several methods used to reconstruct surface geometry by projecting illumination marks onto the surface of the three-dimensional object to be reproduced. For instance, if a spot of light is projected on to a surface from a known angle, and an image of the spot is taken from a second known angle, the distance of the surface from the camera can be calculated by triangulation. Since the angle of the spot to the projector is known, the angle of the camera to the spot is known, and the distance between the camera and the projector is known, the triangle can be solved to determine the distance of each fiducial from the camera and hence the orientation of the document surface with respect to the camera.

In another known method used in the Cyberware 3030RGB/PS scanner, a laser line is projected on a surface from an oblique angle relative to a camera. The camera takes a picture of the line, and from the shape of the line the contour of the surface can be reconstructed.

One of the main disadvantages of reproducing documents by projecting illumination marks is the necessity of taking at least two images while the camera retains a fixed position. Specifically, in order to maintain a fixed position the camera needs to be affixed to a stationary positioning stand, such as a tripod. However, using a camera affixed to a tripod makes the camera cumbersome and less portable. For instance, prior to obtaining the image of the document with the camera, the user needs to position the camera with respect to the document to ensure that the entire document is being photographed. However, the task of moving the camera becomes much more difficult while attached to a tripod or some other stationary object. In addition, if it is desired to take a picture of a page of a book opened on a table top, a specialized camera tripod is required that positions the camera face down into the table top. Another disadvantage of this technique is that the two document images (with and without fiducials) used for the reconstruction need to be stored by the camera and hence increases the camera's memory requirements.

What would be desirable is a simplified technique of reproducing an image projected, displayed, or printed on a surface using an image capture device.

### SUMMARY OF THE INVENTION

A system and method of reproducing an image that is projected, displayed, or printed on a surface by capturing a single digital image of the image on the surface with an image capture device is described.

According to the system and method, at least three illumination marks (i.e., fiducials) are projected on the image. The illumination marks have a particular detectable characteristic. A single digital image of the surface is captured by an image capture device to obtain captured data including data corresponding to the image on the surface with the fiducials. Pixel values corresponding to the illumination marks and their corresponding location in the captured image data are detected dependent on the particular characteristic of the illumination mark pixels. The location of the illumination marks is then used to correct for distortion of the image on the surface and the geometry of the surface to obtain undistorted image data. Estimated pixels are determined using neighboring non-illumination mark pixel values and the estimated pixel values are substituted for illumination mark pixels in the undistorted image data.

### BRIEF DESCRIPTION OF THE DRAWINGS

The objects, features, and advantages of the present invention will be apparent to one skilled in the art, in view of the following detailed descriptions in which:

FIG. 1 illustrates a flow chart showing the steps of a prior art method of reproducing a document with an image capture device;

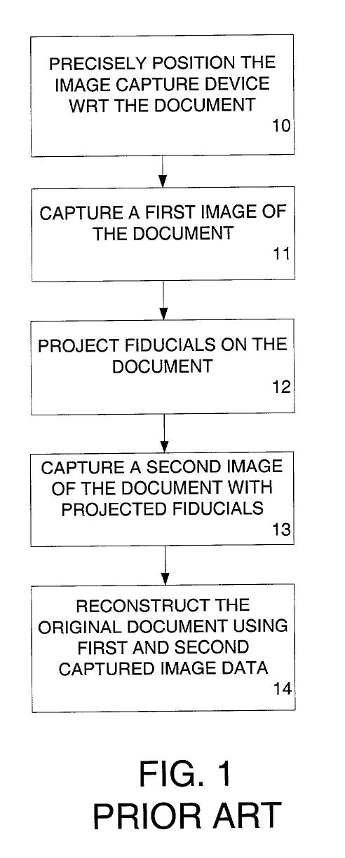

FIG. 2 shows examples of images obtained when performing the prior art method shown in FIG. 1;

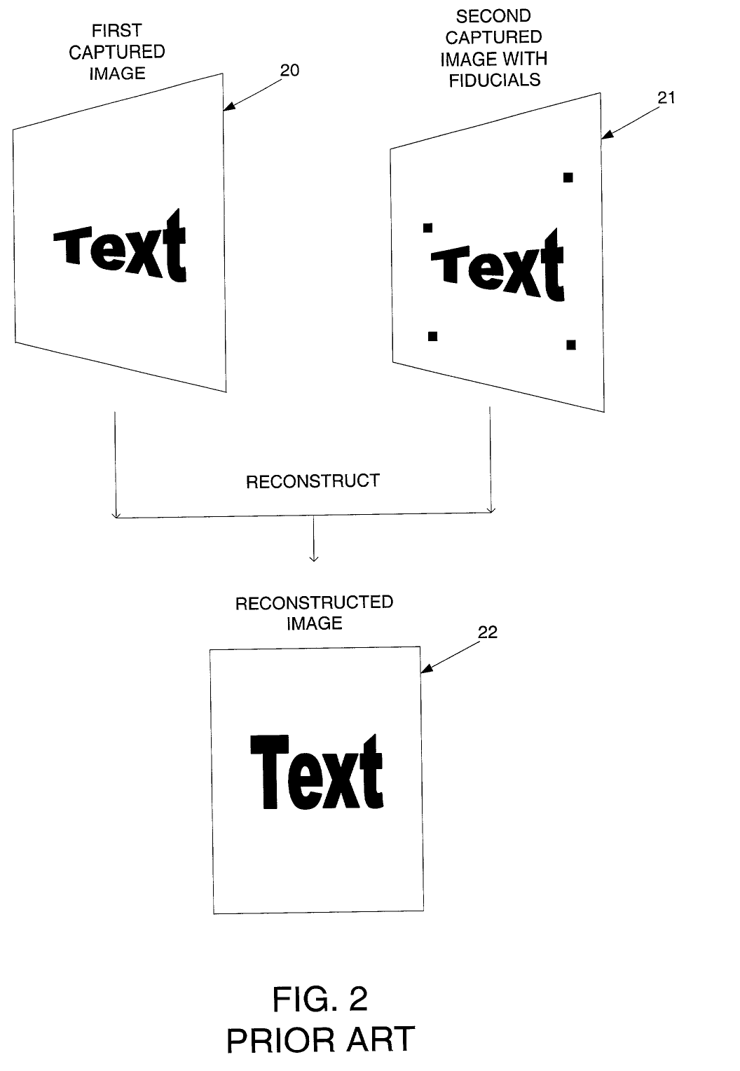

FIG. 3 illustrates one embodiment of the system of the present invention for obtaining a reconstructed digital image of an image projected, displayed, or printed on a surface;

FIG. 4 illustrates one technique for determining the orientation of the document surface with respect to the image capture device;

FIG. 5 illustrates a flow chart showing one embodiment of the method of the present invention of obtaining a reconstructed digital image of an image projected, displayed, or printed on a surface;

FIG. 6 shows examples of document images obtained when performing the method shown in FIG. 4; and

FIG. 7 illustrates a flow chart showing a second embodiment of the method of the present invention of obtaining a reconstructed digital image of an image projected, displayed, or printed on a surface.

### DETAILED DESCRIPTION OF THE INVENTION

In general, the present invention is a system and method of obtaining a reconstructed digital image of a projected, displayed, or printed image on a surface using an image capture device. Examples of an image on a surface include but are not limited to printed images on a media sheet, a projected image on a projection surface, a displayed image on a monitor, and a drawn image on an erasable display board. Images can include text, graphical images, and photographs.

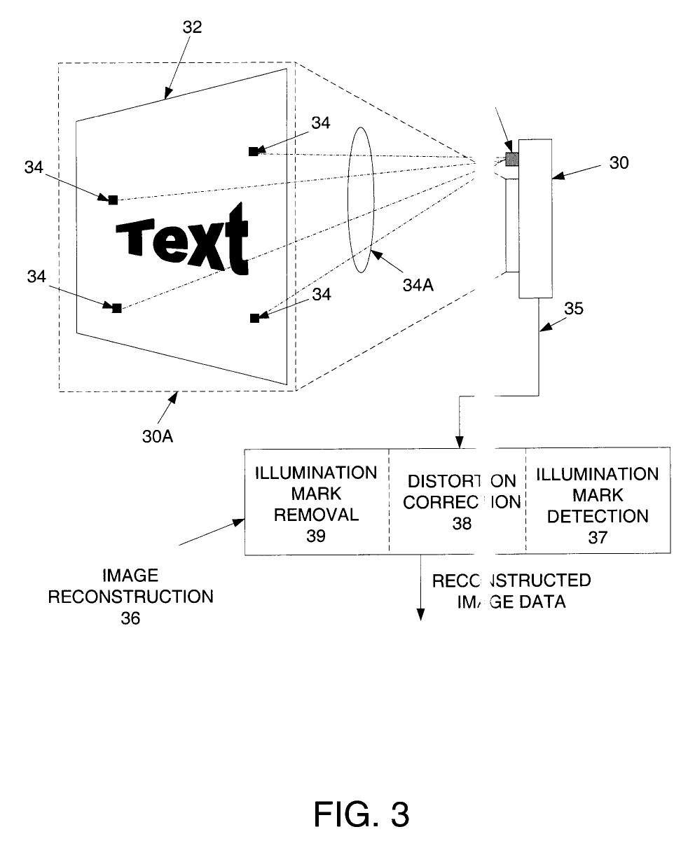

FIG. 3 shows a first embodiment of a system for obtaining a reconstructed digital image of an image projected, displayed, or printed on a surface. FIG. 3 shows an image capture device 30 having a corresponding image capture area 30A. Within the capture area is a surface 32 (e.g., sheet of paper) having an image on it (e.g. printed text). Also shown in FIG. 3 is an illuminator 31 for projecting illumination projections 34A to form illumination marks 34, referred to as fiducials, onto surface 32. In accordance with the system shown in FIG. 3, the illumination marks can be projected onto any area on the surface 32. For instance, although the marks are shown in FIG. 3 in non-text areas on surface 32, the illumination marks can be positioned over text printed on the surface 32.

Image capture device 30 captures the image of surface 32 in capture area 30A to obtain captured digital image data 35 which is coupled to image reconstruction block 36. Image reconstruction block 36 includes an illumination mark detection block 37, a distortion correction block 38, and an illumination mark removal block 39. The illumination mark detector 37 detects the pixel values and their corresponding coordinate location of the illumination marks in the captured data 35 by detecting a particular characteristic of the illumination marks. The distortion correction block 38 uses the illumination mark location information to correct distortion resulting from the relative position of the sensor in the image capture device to the surface 32. Hence, distortion correction block 38 generates undistorted image data from the captured image data 35. The illumination mark removal block 39 functions to substitute estimated pixel values obtained from neighboring non-illumination mark pixel values for the pixel values corresponding to the illumination marks. In one embodiment, neighboring pixel values are interpolated to obtain estimated pixel values. In another embodiment, neighboring pixel values are duplicated and are substituted for the illumination mark pixel values. In other embodiments more complex techniques of estimation can be employed.

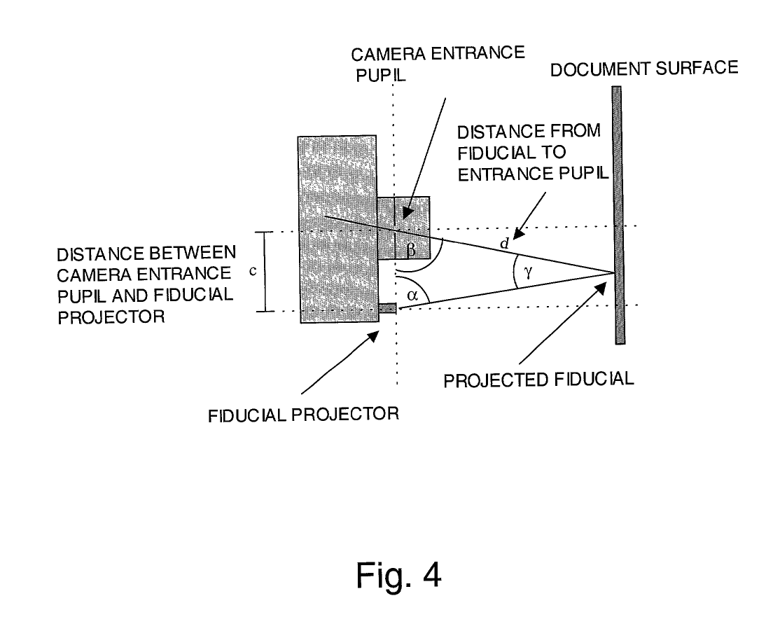

Distortion correction is performed by using: 1) the location of the illumination marks within the captured image data, 2) known orientation information about the angle at which the illumination marks were projected relative to each other, and the camera and 3) known positional information between the camera and illumination mark projector. Referring to FIG. 4, the angle α of the projector to the spot is known since the projector projects the spot in a fixed direction. The angle β from the entrance pupil of the camera to the spot is determined by the location of the spot in the image. The distance c between the projector and the camera is known. The distance d of the spot from the entrance pupil of the camera can then be determined as follows:

γ=180°−α−β

d=c sin(α)/sin(γ)

Three marks are sufficient to define a plane, which would define the actual orientation of the document surface. The actual orientation of the surface can be compared to a desired orientation to determine a displacement value for each pixel location in the captured image data of the surface. The displacement value can then be used to convert actual orientation to desired orientation by shifting pixel locations in the captured image data using the displacement value. In one embodiment, the desired orientation is orthogonal to the entrance pupil along all axes. If more marks are used, the curvature of the document can be determined as well.

In one embodiment, the image capture device is a digital still or video camera in an arbitrary position with respect to the surface and arranged so as to capture all of surface 32 within its image capture area within a known time delay. It is well known in the field of digital image capture that an image is captured by a digital camera using an array of sensors (e.g., CCDs and CMOS) that detect the intensity of the light impinging on the sensors within the capture area of the camera. The light intensity signals are then converted into digital image data corresponding to the captured image. Hence, the captured image data 35 is digital image data corresponding to the captured image. In another embodiment the image capture device is an analog still or video camera and captured analog image data is converted into captured digital image data 35.

It should be understood that all or a portion of the functions of the image reconstruction block 36 can be performed by a computing system including at least a central processing unit (CPU) and a memory for storing digital data (e.g., image data).

It should be further understood that the image reconstruction block 36 can be implemented in a software implementation, hardware implementation, or any combination of software and hardware implementations.

In one embodiment of the illumination markings, at least three or more illumination marks are employed having an illumination characteristic detectable by analysis of the captured image data 35. For instance, in one embodiment, the illumination markings are generated from a laser illumination source of a single color component (e.g., red, green, blue) and when the illumination marks are captured by the image capture device, the intensity level of the single color component illumination mark pixel values is easily discriminated from the non-illumination mark pixel values. In this embodiment, pixel values of a particular single color component that exceed a selected intensity value can be detected as illumination mark pixel values.

In another embodiment of the illumination marks, the marks are embodied as dots configured in a pattern such as a grid or an array, each dot covering multiple pixels in the captured image of the image on the surface. In accordance with this embodiment, illuminator 31 can be embodied as a single laser source passed through a holographic/diffraction grating. In another embodiment, multiple laser sources are employed each projecting a separate illumination mark on the surface. In still another embodiment, an image is projected using a system of lenses, such as those that are used in a slide projector.

In one embodiment of the image capture device, the device comprises a light sensor having a plurality of sensors arranged in an array, such as an array of CCD sensors. The projected marks are recorded by the capture device as bright spots isolated from document image information both spatially and in color. Detection can be achieved with well-known methods such as thresholding or matched filtering. When the marks are detected, their positions can be recorded and they can be removed from the digital image by interpolating using well known algorithms that are used to compensate for defective sensor pixels. One known algorithm referred to as “impulse noise removal”, is described in “Digital Image Processing” by Gonzalez and Wintz, 1987.

In another embodiment, the image capture device uses a system of color filters positioned in front of the sensor array or set of arrays to produce a plurality of color channels. Each of the filters only allows light of a certain frequency band to pass through it. To improve detection of the marks and the reconstruction of the image with the marks removed, the color spectrum of the marks, the band pass of the filters, and the frequency sensitivity of the sensors can be jointly designed so that only one of the color channels records the marks. In this embodiment, the marks can be detected in a single color channel. To reconstruct the image without the marks, only that channel needs interpolation.

In a variation of this embodiment, the color channel used for the marks is chosen so that it is not essential for recovering the image without the marks. For instance, an additional color channel, such as infrared, can be used to capture an image of the marks, and the color of the surface can be captured with the remaining color channels. In a further example, if it is known that the document is black and white, the marks can be captured in one color channel, such as red, and the document can be captured with a different color channel, such as green.

In another embodiment in which the image capture device comprises a light sensor having a plurality of sensors arranged in an array, such as an array of CCD sensors, each of the sensors detects a given intensity and band of spectral light thus providing an array of detected light samples. Color information is obtained from the light samples using a patterned color filter referred to as a color filter array (CFA) or a color mosaic pattern that produces a mosaiced array of digital color data. In order to obtain a useable digital color representation of the image in which a set of colors define each pixel location of the image (e.g., red, green, and blue) it is necessary to demosaic the mosaiced color data. This is achieved by well known interpolation methods that are beyond the scope of this application. In accordance with this embodiment in which the image capture device is implemented with a patterned color filter, the filter is implemented such that filters not corresponding to the illumination mark color spectrum band are insensitive to the illumination mark color spectrum band.

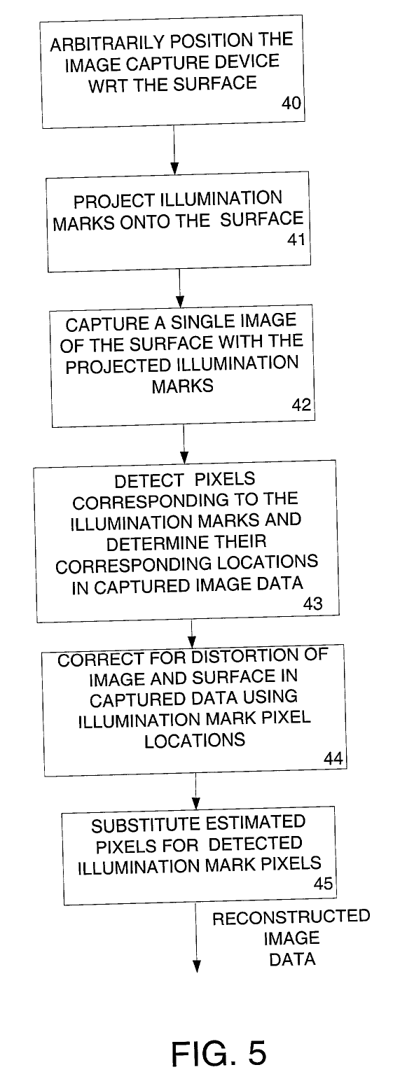

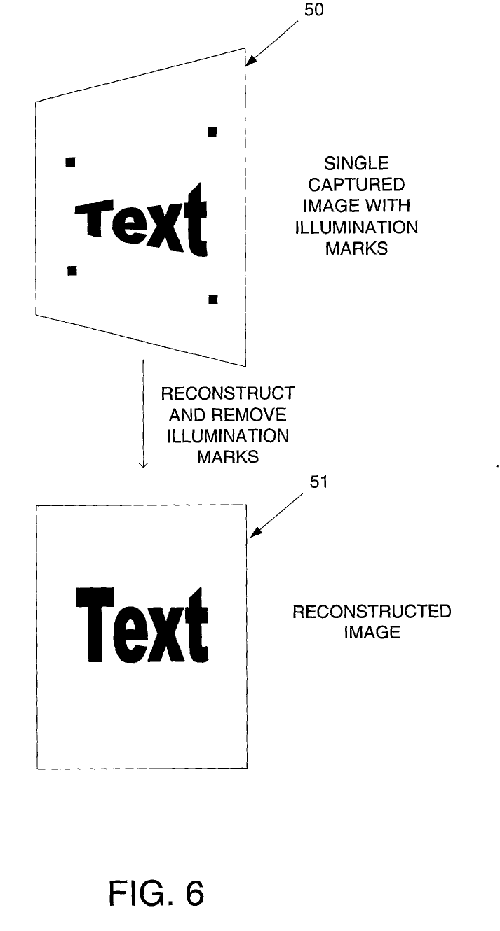

FIG. 5 shows a first embodiment of a method of obtaining a reconstructed digital image of an image projected, displayed, or printed on a surface and FIG. 6 illustrates the images obtained when performing the method shown in FIG. 5. According to this method an image capture device is arbitrarily positioned with respect to the surface (block 40). At least three illumination marks are projected onto the surface (block 41). A single captured image 50 is obtained of the surface with the projected illumination marks (block 42). The pixels corresponding to the illumination marks are detected within the captured image data and their location is determined (block 43). Using the location of the illumination marks in the captured image data, the distortion of the image and the surface is corrected for within the captured image data (block 44). The detected illumination mark pixels are then replaced by estimated pixels to generate reconstructed image data 51 (block 45). It should be understood that according to the method shown in FIG. 5, the substitution of the estimated pixels for the detected illumination mark pixels (block 45) can be performed prior to the correction for distortion of the image and surface in the captured image data (block 44).

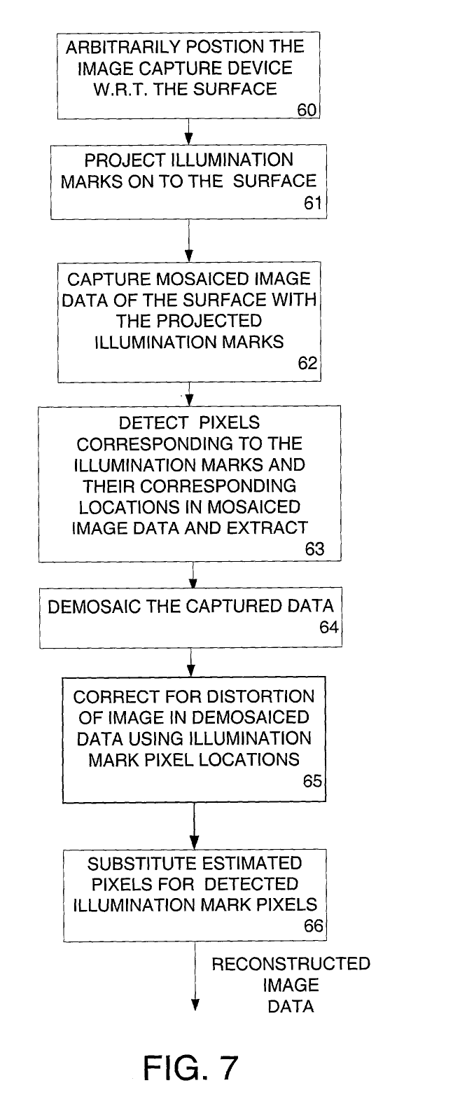

FIG. 7 shows a second embodiment of the method of obtaining a reconstructed digital image of an image projected, displayed, or printed on a surface. In this embodiment, the image capture device is implemented such that the captured image data is in the form of mosaic image data as described above. Referring to FIG. 7, an image capture device is arbitrarily positioned with respect to the surface (block 60). Illumination marks are projected onto the surface (block 61). A single image is captured to obtain mosaiced captured image data of the surface and the image (block 62). The illumination marks are detected within the mosaiced data, are extracted, and their location is determined (block 63). The advantage of extracting illumination mark pixel values from the mosaiced image data prior to demosaicing is that it avoids erroneous results during demosaicing that can occur due to the illumination mark pixel values. The mosaiced image data is demosaiced (block 64). Distortion is removed from the demosaiced image data using the location information of the illumination marks (block 65). The illumination marks are then restored at the predetermined illumination mark coordinate locations within the demosaiced data and the illumination marks are replaced by the estimated pixel values determined using the neighboring pixel values (block 66).

Hence, a system and method for obtaining a reconstructed digital image of an image projected, displayed, or printed on a surface by capturing a single image with an image capture device is described thereby simplifying the prior art two image process.

In the preceding description, specific details are set forth in order to provide a thorough understanding of the present invention. It will be apparent, however, to one skilled in the art that these specific details need not be employed to practice the present invention. In other instances, well-known operations and systems have not been described in detail in order to avoid unnecessarily obscuring the present invention.

In addition, although elements of the present invention have been described in conjunction with certain embodiments, it is appreciated that the invention can be implement in a variety of other ways. Consequently, it is to be understood that the particular embodiments shown and described by way of illustration are in no way intended to be considered limiting. Reference to the details of these embodiments is not intended to limit the scope of the claims which themselves recited only those features regarded as essential to the invention.

I claim:

1. A method of reconstructing a digital image of an image on a surface using a digital image capture device arbitrarily positioned with respect to the surface, the method comprising the steps of:
projecting at least three illumination marks on the surface, said illumination marks having a particular characteristic;
capturing a single image of the surface to obtain captured image data;
detecting pixel values corresponding to the illumination marks and their corresponding location on the surface in the captured image data dependent on the particular characteristic;
using the location of the illumination marks in the captured image data to correct for distortion of the image and the surface in the captured image data to generate undistorted image data; and
substituting estimated pixel values for the detected illumination mark pixel values in the undistorted image data, the estimated pixel values being determined using neighboring non-illumination mark pixel values.

2. The method as described in claim 1 wherein the particular characteristic is the intensity level.

3. The method as described in claim 1 wherein the digital image capture device is a digital camera.

4. The method as described in claim 1 wherein the illumination marks are produced from an illumination source of a single color component having a particular intensity.

5. The method as described in claim 4 wherein the single color illumination source is a laser.

6. The method as described in claim 1 wherein the illumination marks are detected by detecting color component and intensity of the captured image data.

7. The method as described in claim 1 wherein the illumination marks are detected by detecting wavelength of the captured image data.

8. The method as described in claim 1 wherein projecting the at least two illumination marks comprises projecting a grid of illumination marks.

9. The method as described in claim 1 wherein projecting the at least two illumination marks comprises projecting a single illumination source through a diffraction grating.

10. A system of reconstructing a digital image of an image on a surface using a digital image capture device arbitrarily positioned with respect to the surface, the method comprising the steps of:
an illumination source for projecting at least three illumination marks on the surface, said illumination marks having a particular characteristic;
an image capturing device for capturing a single image of the surface to obtain captured image data;
an image reconstructor having means for detecting pixel values corresponding to the illumination marks and their corresponding location on the surface in the captured image data dependent on the particular characteristic, a means for using the location of the illumination marks in the captured image data to correct for distortion of the image in the captured image data to generate undistorted image data, and a means for substituting estimated pixel values determined using neighboring non-illumination mark pixel values for the detected illumination mark pixel values.

11. The system as described in claim 10 wherein the digital image capture device is one of a digital still camera and a digital video camera.

12. The system as described in claim 10 wherein the illumination source is a single color component light source.

13. The system as described in claim 10 wherein the illumination source is a laser.

14. The system as described in claim 10 wherein the illumination marks are detected by detecting color component and intensity.

15. The system as described in claim 10 wherein the at least three illumination marks comprise a grid of illumination marks.

16. The system as described in claim 10 wherein the illumination source comprises a diffraction grating for projecting the illumination source through to form a grid of illumination marks.
